(19) United States
(12) Patent Application Publication
(10) Pub. No.: US 2002/0116697 A1
(43) Pub. Date: Aug. 22, 2002

(54) Methods for calculating, correcting, and displaying segmented reticle patterns for use in charged-particle-beam microlithography, and screen editors utilizing such methods

(75) Inventors: Kazuya Okamoto, Yokohama-shi (JP); Koichi Kamijo, Kumagaya-shi (JP); Shinichi Kojima, Wappingers Falls, NY (US)

Correspondence Address: KLARQUIST SPARKMAN, LLP, One World Trade Center, Suite 1600, 121 S.W. Salmon Street, Portland, OR, 97204-2988, US

(73) Assignee: Nikon Corporation

(21) Appl. No.: 10/081,760

(22) Filed: Feb. 20, 2002

(30) Foreign Application Priority Data
Feb. 20, 2001 (JP) 2001-042620

(51) Int. Cl. G06F 17/50

(52) U.S. Cl. 716/21

(57) ABSTRACT

Methods are disclosed for calculating, correcting, and displaying a pattern to be defined on a segmented reticle such as used in charged-particle-beam (CPB) microlithography. In an embodiment, the methods are performed by a computer-enabled screen editor. Data concerning dimensional and configurational properties of the reticle, the microlithography apparatus with which the reticle is to be used, and the pattern to be transferred are entered. Execution of the method divides the pattern into subfields of a segmented reticle. The subfields are arranged into one or more stripes, and the respective locations of subfields within the stripe(s) are optimized. Respective pattern elements defined in the subfields may be modified to reduce space-charge and/or coulomb effects. The respective pattern portions defined in the subfields may be searched for critical pattern elements situated on division boundaries. Any such elements are corrected by modifying the pattern element or the respective subfield. Any of various steps and results obtained during execution of the method may be displayed to a user.

### FIELD

This disclosure pertains to microlithography (the transfer of a pattern to a sensitive substrate). Microlithography is a key technology used in the fabrication of microelectronic devices such as integrated circuits, displays, and micromachines. More specifically, this disclosure relates to charged-particle-beam (CPB) microlithography utilizing a segmented reticle and to computer-enabled screen editors used for converting a pattern design into an actual divided-reticle pattern as defined on a segmented reticle.

### BACKGROUND

With the relentless drive toward progressively smaller feature sizes, pattern-resolution limitations of conventional optical microlithography systems have become a major obstacle. To overcome this obstacle, microlithography systems utilizing a charged particle beam, such as an electron beam, have been developed. In charged-particle-beam (CPB) microlithography, however, it is not possible to project an entire pattern in one shot from the reticle to the substrate. Instead, in a process known as “divided-reticle pattern transfer,” the pattern is divided into individual exposure units, termed “subfields,” that are defined on a “divided” or “segmented reticle” and exposed in a prescribed order, subfield-by-subfield. As the pattern is transferred from the segmented reticle to the substrate, the subfield images are positioned on the substrate so that they collectively form a single contiguous transferred pattern. This process involving the positioning of subfield images relative to each other is termed “stitching” and must be performed with extreme accuracy.

FIG. 11 is a plan view of a substrate schematically showing various subdivisions associated with divided-reticle pattern transfer. The terms used to denote the various subdivisions are derived from the manner in which the pattern to be transferred is defined on the segmented reticle. Generally speaking, the segmented reticle comprises a thin membrane divided into one or multiple regions termed “stripes” by structural elements known as “major struts.” Each stripe is further subdivided into multiple rows of subfields separated from each other by smaller structural elements termed “minor struts.” An individual subfield comprises a respective pattern-defining region of the membrane, defining a respective portion of the reticle pattern. In each subfield the respective pattern-defining region is peripherally surrounded by an unpatterned portion of the membrane, termed a “skirt.”

When an image of a subfield is projected onto a substrate (in FIG. 11, the image is projected in a “chip” 112 on a “wafer” 111), a corresponding “transferred subfield” 115 is formed. Upon completing exposure of all the subfields in a stripe, the transferred subfields 115 collectively form a transferred stripe 113 in the chip 112. The transferred subfields are arranged in rows 114 of the transferred stripe 113. Finally, upon completing exposure of all the stripes of the reticle, the transferred stripes 113 collectively form an entire transferred chip or “die” on the wafer 111. Typically, multiple chips 112 are formed on the wafer 111.

FIG. 12 is a perspective view schematically showing exposure of a stripe 121 of a segmented reticle onto a substrate using a conventional CPB microlithography system. The reticle (R) and the substrate (S) are mounted on respective movable stages (not shown). Between the reticle R and substrate S is a projection-optical system POS that projects an image of a subfield SF, illuminated by an “illumination beam” IB, onto a selected region on the substrate S. The illumination beam IB is the portion of the charged particle beam 123 upstream of the reticle R. The portion of the charged particle beam 123 downstream of the reticle R is termed the “patterned beam” PB because it carries an aerial image of the illuminated subfield SF to the substrate S.

Exposure of the stripe 121 begins at the first row 124 of the stripe and at the first corresponding region 125 on the transfer-stripe region 122 on the substrate S. During exposure of the stripe 121 the stages move in mutually opposite directions and at continuous respective velocities (shown by the respective arrows) corresponding roughly to the demagnification ratio of the projection-optical system. Meanwhile, the illumination beam IB is deflected laterally as required in a continuous manner to illuminate the subfields in each row in a sequential manner (note respective “beam deflection” arrow), while the patterned beam PB is deflected laterally as required in a continuous manner to image the subfields of each row in a sequential manner (note respective “beam deflection” arrow) on the substrate S. Deflections of the illumination beam IB and patterned beam PB are also made as required in directions parallel to respective stage-motion directions to enable the beams to “follow” the subfields in the row being exposed as the row moves in the respective stage-scanning direction. This scheme of continuous motion and beam deflection provides maximal throughput.

FIG. 13(a) is a plan view schematically showing a portion of a first type of segmented reticle utilized in CPB microlithography. The subfields 132 are arrayed in rows in the two depicted stripes 131. In this figure, for ease of illustration, each stripe 131 comprises fifteen rows of four subfields. In this type of reticle the subfields 132 in each row and the rows of each stripe 131 are separated from each other by respective minor struts 134, and the stripes 131 are separated by major struts 133. The struts 133, 134 provide structural strength and rigidity to the reticle. During exposure of a stripe 131, the illumination beam is swept in a continuous manner in each row, but each subfield in the row is exposed individually in a sequential manner.

FIG. 13(b) is a plan view schematically showing a portion of a second type of segmented reticle used in CPB microlithography. In contrast to the reticle of FIG. 13(a), the subfields in each row of the reticle of FIG. 13(b) are not separated by minor struts; rather, the subfields are arranged contiguously in each row as a single deflection band 135. The deflection bands 135 extend along the scanning path of the illumination beam IB and are exposed in respective continuous sweeps of the illumination beam. Meanwhile, the patterned beam projects an image of each deflection band 135 in a continuous manner on the substrate.

CPB microlithography differs from optical microlithography in other important respects as well. For instance, reticles utilized in optical microlithography typically are not segmented. Consequently, computer programs (termed “screen editors”) used for converting a pattern design into an actual pattern defined on a reticle used in optical microlithography need not take into account various effects caused by having to divide the pattern. Rather, in making such reticles, pattern-design data are transmitted by the screen editor directly to a “mask writer,” in which a data converter converts the pattern-design data directly for use by the mask writer.

In producing a divided reticle for CPB microlithography, in contrast, if a conventional screen editor is used, division of the pattern occurs only after the data has been transmitted to the mask writer. Most mask writers, however, are capable only of performing data conversion, not other desirable functions such as displaying the profiles of pattern elements subject to division among multiple subfields or the like.

Furthermore, dividing a pattern so that it can be defined on a segmented reticle is not simply a matter of geometrically dividing pattern elements. Rather, the reticle pattern must be designed carefully so that “division boundaries” (e.g., between adjacent subfields) extend across the fewest possible pattern elements that define active, or critical, circuit elements (e.g., transistors). Otherwise, a “stitching error” arising during lithographic pattern transfer may cause the affected element not to function or to function improperly. Ideally, the pattern is designed so that division boundaries extend across only passive circuit elements such as wiring elements. Conventionally, this ideal is extremely difficult to achieve.

Therefore, there is a need for screen editors that can take into account possible adverse effects inherent in pattern division, and that can make appropriate corrections to the pattern (as defined on the reticle) to reduce such effects. There also is a need for screen editors capable of displaying the profiles of divided pattern elements and that can respond constructively to commands from an operator desiring to make appropriate changes to the pattern design and manner of division.

### SUMMARY

In view of the shortcomings of conventional screen writers and of the unique challenges presented by divided-reticle pattern transfer, the present invention provides, inter alia, methods for calculating, correcting, and displaying the reticle pattern before the pattern is routed to a mask writer. The invention also provides screen writers using such methods.

According to a first aspect of the invention, methods are provided for converting a pattern design into a divided-reticle pattern on a segmented reticle for use in a charged-particle-beam (CPB) microlithography system. An embodiment of such a method includes the following steps. On a data set including current pattern-design data and current reticle data, multiple process routines are performed so as to produce reticle-fabrication data. The process routines include display processing and at least one of subfield-division processing and stripe-division processing. Based on results obtained during the process routines, the pattern design is converted into the divided-reticle pattern. Usually, during the converting step, the pattern design is divided among multiple subfields of the divided reticle. Data concerning the divided-reticle pattern are usable directly by a mask writer.

Desirably, among the process routines, subfield-division processing is performed first, followed by stripe-division processing. Stripe-division processing involves arranging the subfields into one or more stripes. After performing one or both these process routines on the reticle-fabrication data, a determination can be made as to whether any of several other process routines (summarized below) is indicated. If an additional process routine is indicated, then the additional process routine is performed.

The current reticle data typically includes dimensional and configurational data concerning one or more of: the overall reticle, major and minor struts of the reticle, individual stripes of the reticle, individual rows of a stripe, individual subfields of a row, and pattern-defining regions, skirts, and superposable regions of the subfields.

The data set can further include current microlithography system data, which typically includes data concerning one or more of: aberrations, beam-acceleration voltage, beam current, range of lateral beam deflection, etching conditions, and reticle-processing conditions.

In the subfield-division routine the pattern design is converted into the divided-reticle pattern. Desirably, in this routine, the divided-reticle pattern is searched for pattern portions defining respective critical pattern elements extending across respective subfield-division boundaries. For such pattern portions that are found, the respective critical elements are configured so as to extend into respective superposable regions of respective subfields rather than across respective subfield-division boundaries.

The stripe-division routine desirably includes performing a first arrangement of the subfields, in which arrangement the subfields are arranged into at least one stripe having opposing longitudinal edges and a longitudinal mid-line. If, in the first arrangement, the stripe contains both “patterned” subfields and “empty” (non-patterned) subfields, then the patterned subfields are arranged preferentially along the mid-line and the empty subfields are arranged preferentially along the longitudinal edges, thereby providing an optimal arrangement of subfields in the stripe.

The other process routines mentioned above can include one or both of correction processing and avoidance processing.

In the correction-processing routine, certain corrections are made to reduce adverse effects of phenomena such as the proximity effect and/or the coulomb effect. For example, for the particular reticle pattern being configured, the impact of the proximity effect on expected pattern-transfer accuracy of the divided-reticle pattern is calculated. Based on the results of the calculations, the divided-reticle pattern is corrected to compensate, at least in part, for the proximity effect. A similar series of calculation and correction steps can be performed to reduce the coulomb effect. For example, image blur expected to be caused by the coulomb effect is calculated; based on the results of the calculations, selected elements of the pattern are reshaped and resized as required to reduce the coulomb effect.

In the avoidance-processing routine, certain pattern elements are reconfigured to avoid extensions of the elements across division boundaries, thereby avoiding possible stitching problems. The divided-reticle pattern is searched (manually or automatically) for pattern portions that define respective critical pattern elements; a determination is made of whether the critical pattern elements extend across respective division boundaries. For such critical pattern portions that are found, a determination is made of whether the respective critical elements can be corrected so as not to extend across respective division boundaries. For such critical pattern portions that can be corrected, the respective critical elements are corrected. During execution of this routine, pattern portions defining respective critical pattern elements extending across respective division boundaries can be displayed. Alternatively or in addition, the corrected elements can be displayed.

The display-processing routine involves subfield display, stripe display, and/or correction-processing display (if performed). Subfield display includes displaying at least a portion of the divided-reticle pattern with at least one line representing a subfield-division boundary superimposed on the displayed pattern. Stripe display includes displaying at least one stripe of the divided-reticle pattern showing an arrangement of patterned versus empty subfields in the stripe. Correction-processing display includes displaying at least one corrected portion of the divided-reticle pattern. In addition, display processing can result in display of support structures of the divided reticle (e.g., major and minor struts). Display processing also can include display of calculations executed to correct any undesired effects or results that could arise from the divided-reticle pattern. In general, display is advantageous because it allows the operator visually to inspect results obtained by during execution of the method, and also allows the operator to intervene as required in the execution of and in the results obtained by the method. For example, if the operator is dissatisfied with the divided-reticle pattern resulting from automatic execution of the method, then the operator can adjust pattern-division conditions and/or other variables as necessary to optimize the divided-reticle pattern.

Another aspect of the invention is directed to computer programs encoding any of the methods according to the invention.

Yet another aspect of the invention is directed to computer-readable media that comprise any computer program according to the invention.

Yet another aspect of the invention is directed to computers that are programmed with any computer program according to the invention.

Yet another aspect of the invention is directed to screen editors for use in designing a divided-reticle pattern to be transferred lithographically from a segmented reticle to a substrate using a charged-particle-beam (CPB) microlithography system. An embodiment of such a screen editor comprises means for receiving a data set relating to a design of a pattern to be transferred to the substrate and current reticle configuration. The screen editor also comprises means for converting, according to the received data, the pattern design into a corresponding divided-reticle pattern in which the pattern is divided into at least one of subfields and stripes. The screen editor desirably further comprises means for displaying at least selected portions of the pattern before, during, and/or after conversion of the pattern design into the corresponding divided-reticle pattern.

The “means for converting” summarized above desirably includes means for identifying, during conversion, pattern elements that could be problematical when transferred from the segmented reticle, and means for correcting said pattern elements to avoid problems during transfer. The means for converting can include means for dividing the pattern into multiple subfields according to the received data. Alternatively or in addition, the means for converting can include means for performing a first arrangement of the multiple subfields into at least one stripe having opposing longitudinal edges, a longitudinal mid-line, and at least one row of respective subfields, and means for performing, if in the first arrangement the stripe contains both patterned subfields and empty subfields, a second arrangement in which patterned subfields of the stripe are arranged preferentially along the mid-line and the empty subfields are arranged preferentially along the respective longitudinal edges of the stripe. Alternatively or in addition, the means for converting can include means for calculating an impact of the proximity effect on expected pattern-transfer accuracy of the divided-reticle pattern, and means for correcting the divided-reticle pattern to compensate, at least in part, for the proximity effect Alternatively or in addition, the means for converting can include means for calculating an impact of the coulomb effect on expected pattern-transfer accuracy of the divided-reticle pattern, and means for correcting the divided-reticle pattern to compensate, at least in part, for the coulomb effect. Alternatively or in addition, the means for converting can include means for searching the divided-reticle pattern for pattern portions defining respective critical pattern elements and for determining whether the critical pattern elements extend across respective division boundaries, and means for correcting, for such pattern portions that are found, the respective critical elements so as not to extend across the respective division boundaries.

The “means for receiving data” summarized above can be a manual data-input means or means for receiving computer-readable data.

The “means for correcting” summarized above desirably reconfigures a respective critical element so as to extend no further than into a superposable region of a respective subfield containing the critical element. Alternatively or in addition, the means for correcting reconfigures a respective critical element such that the respective division boundary does not divide the element.

According to another aspect of the invention, methods are provided for converting a pattern design into a divided-reticle pattern. An embodiment of such a method comprises the step of dividing the pattern design into multiple subfields according to predetermined dimensions and configurations of subfields, respective pattern-defining regions in the subfields, and skirts in the subfields, wherein the subfields define respective portions of the pattern. The method embodiment includes the step of displaying the divided-reticle pattern. The method can further comprise the steps of: (1) arranging the multiple subfields into at least one stripe according to predetermined dimensions and configurations of stripes, major struts, and minor struts, and (2) displaying the arranged subfields.

If the arranged subfields include patterned subfields and empty subfields, the method can further comprise the step of determining, in the at least one stripe, whether the patterned subfields and empty subfields are located optimally within respective rows of the stripe. If the patterned subfields and empty subfields are not optimally located in the at least one stripe, then the subfields can be rearranged to establish an optimal arrangement of subfields within the at least one stripe, accompanied by a display of the rearranged subfields.

Further with respect to this method, calculations can be made, in the subfields, of the impacts of proximity effects. As required, the divided-reticle pattern is corrected to compensate for the proximity effects, accompanied by a display of the corrected divided-reticle pattern. Alternatively or in addition, impacts of coulomb effects in the subfields can be calculated. As required, the divided-reticle pattern is corrected to compensate for the coulomb effects, accompanied by a display of the corrected divided-reticle pattern.

The method can include the step of searching the divided-reticle pattern for pattern portions defining respective critical pattern elements extending across respective division boundaries of the pattern. For critical pattern elements found extending across respective division boundaries of the pattern, the respective pattern portions are corrected so as not to extend across the respective division boundaries, accompanied by a display of the corrected divided reticle pattern. With respect to correcting the respective pattern portions, for each such pattern portion, the respective critical pattern element can be configured to extend into a respective superposable region of the respective subfield, according to predetermined dimensions and configurations of the superposable regions. Alternatively or in addition, for each such pattern portion, the respective pattern portion can be configured so that the respective division boundary does not divide the respective pattern portion.

The foregoing and additional features and advantages of the invention will be more readily apparent from the following detailed description, which proceeds with reference to the accompanying drawings.

### BRIEF DESCRIPTION OF THE DRAWINGS

FIG. 1 is a flowchart showing the main functions of a screen editor according to a representative embodiment.

FIG. 2 is a flowchart of the subfield-division processing routine in the method shown in FIG. 1.

FIG. 3 is a flowchart of the stripe-division processing routine in the method shown in FIG. 1.

FIG. 4 is a flowchart of the correction processing routine in the method shown in FIG. 1.

FIG. 5 is a flowchart of the avoidance processing routine in the method shown in FIG. 1.

FIG. 6 is a flowchart of the display processing routine in the method shown in FIG. 1.

FIGS. 7(a) and 7(b) are schematic plan views of two stripes before and after, respectively, performing stripe-division processing to optimize the locations within stripes of “patterned” subfields (defining respective pattern portions) versus “empty” subfields (defining no respective pattern portions).

FIGS. 8(a), 8(b), and 8(c) are schematic plan views of two adjacent subfields, in which a portion of a pattern element in the first subfield extends into the superposable region of the first subfield (FIG. 8(c)), rather than extending across the mutual division boundary into the second subfield (FIGS. 8(a)-8(b)), thereby avoiding a stitching error.

FIGS. 9(a) and 9(b) are schematic plan views depicting the effect of the automatic wiring function of the subject screen writer. Two adjacent subfields are shown, in which a pattern element extending from the second subfield across the mutual division boundary (FIG. 9(a)) is shortened sufficiently to place the pattern element entirely within the second subfield (FIG. 9(b)), thereby avoiding division of the pattern element.

FIGS. 10(a), 10(b), and 10(c) are schematic plan views showing the correction of proximity effects in a subfield using a first GHOST technique (FIGS. 10(a) and 10(b)) and a second GHOST technique (FIG. 10(c)).

FIG. 11 is a plan view of a wafer (lithographic substrate) schematically depicting multiple chips on the wafer, multiple stripes within each chip, and multiple rows of subfields in each stripe, characteristic of conventional divided-reticle pattern transfer.

FIG. 12. is a perspective view schematically depicting certain aspects of the illumination of subfields on a reticle and the projection of the illuminated subfields onto a substrate, as conventionally performed using a charged particle beam.

FIG. 13(a) is a plan view schematically depicting two stripes of a conventional segmented reticle as used in CPB microlithography, wherein the subfields in each row in each stripe are separated from each other by intervening struts.

FIG. 13(b) is a plan view schematically depicting a single stripe of a conventional segmented reticle in which the subfields in each row are contiguous with each other in the form of deflection bands.

### DETAILED DESCRIPTION

This invention is described below in connection with representative embodiments that are not intended to be limiting in any way. The embodiments are disclosed in part by flow charts that are particularly useful in explaining certain features of the subject methods.

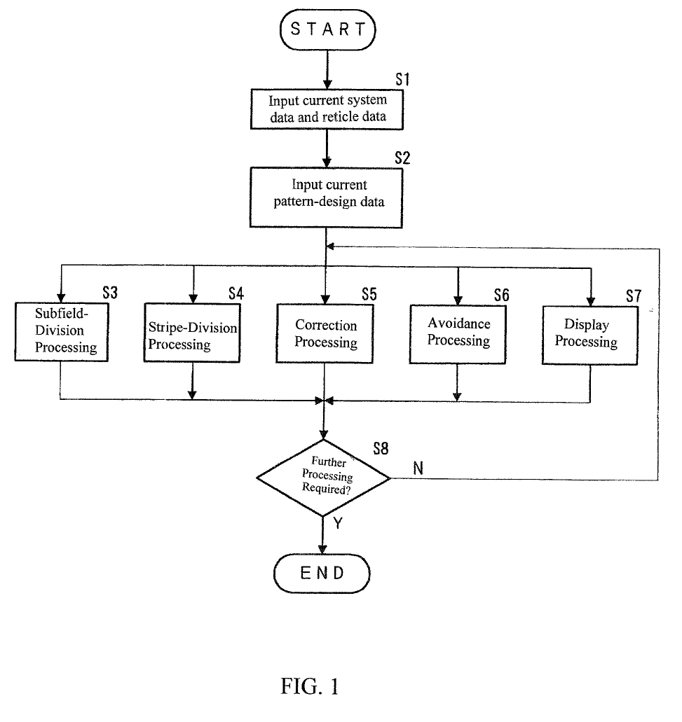

Reference is made first to FIG. 1, which is a flow chart of steps showing the overall operation of the screen editor.

In step S1, current system data relating to the particular segmented reticle to be formed and the particular CPB microlithography system with which the reticle is to be used are input. Although this data can be input manually, the data desirably are transferred from an existing computer-readable file containing the system settings and various system and operational parameter data. The current data relating to the particular segmented reticle to be formed comprise respective dimensions and configurations of the pattern-defining portion(s) of the reticle, as well as dimensional and configurational data concerning the subfields, the respective pattern-defining areas and skirts within the subfields, the stripes, any superposable regions of the subfields, major struts, and minor struts, for example. The current data relating to the particular CPB microlithography system being used comprise information specific to the CPB exposure system (e.g., aberrations, beam-acceleration voltage, beam current, beam-deflection range, etc.) and to the reticle-processing conditions (e.g., etching and resist conditions, etc.).

In step S2, current pattern-design data relating to the pattern (e.g., “LSI pattern”) to be defined on the reticle for transfer are input. This design data comprise data concerning the overall configuration of the pattern, the respective profiles of the constituent pattern elements and of groups of pattern elements, and other design features of the pattern. This data may be input manually by an operator or automatically by functions contained within the screen editor. Although step S2 is shown as occurring after step SI, step S2 alternatively may be performed first. Additionally, step S2 does not require that all the current design data be input before proceeding to steps S3-S7.

After the current pattern-design data are input (step S2), at least one of the following processing routines is performed as necessary: subfield-division processing (step S3), stripe-division processing (step S4), correction processing (step S5), avoidance processing (step S6), and display processing (step S7). Upon concluding one of these respective routines, a determination is made at step S8 as to whether and what further processing (among the processing routines S3-S7) is necessary. This determination may be based upon settings previously used in other of the processing routines or may be made manually by the operator. For instance, display processing (step S7) may be performed upon completion of any of the other processing routines S3-S7. If step S8 reveals that further processing is required, then the particular required processing routine is performed; otherwise, processing ceases. Desirably, the first (or only, if no other) processing routine to be performed is subfield-division processing S3.

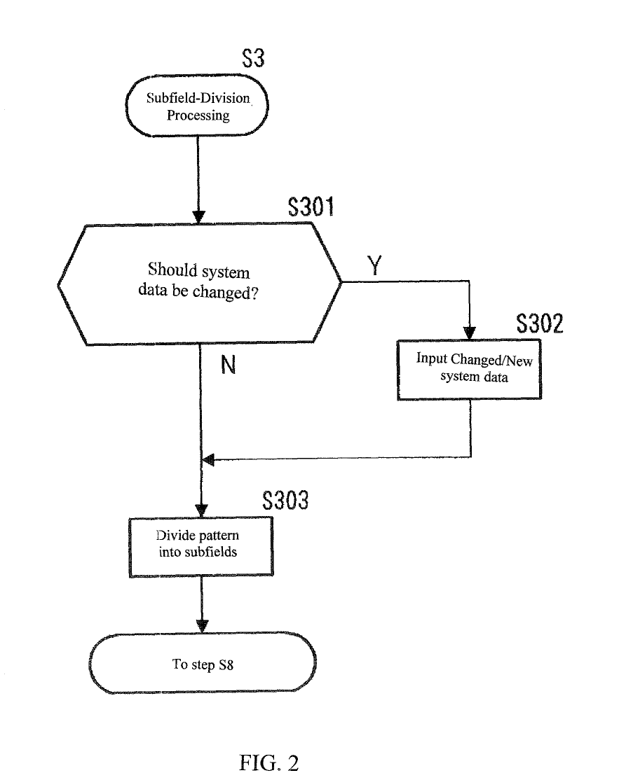

FIG. 2 is a flow chart showing an overview of subfield-division processing S3. At step S301, a determination is made as to whether any of the system data should be changed. If so (denoted by the “Y” in FIG. 2), then the new or changed data is input at step S302 by manual entry of the data or by other suitable means (e.g., transfer from a different computer-readable file or by automatic adjustment by the screen editor). After the new data is entered, or if step S301 reveals that no new data is required (denoted by the “N” in FIG. 2), then, at step S303, the pattern is divided into multiple subfields. This subfield division takes into account, for example, the pattern-defining regions and skirt sizes of the segmented reticle.

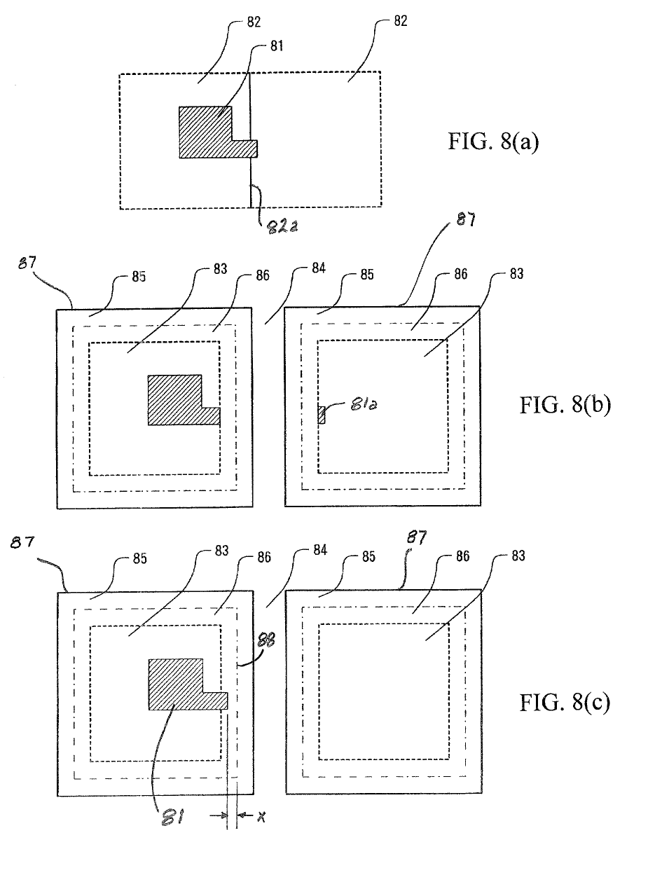

FIGS. 8(a)-8(c) depict a representative method for reducing stitching error that may be employed during subfield-division processing at step S303. The method of FIGS. 8(a)-8(c) utilizes a superposable region of a subfield to reduce stitching error at a mutual division boundary of two subfields projected onto the wafer. FIG. 8(a) shows the position of a pattern element 81 after a subfield-division boundary 82a has been determined in step S303 for two adjacent subfields 82. As can be seen, the division boundary 82a (shown by a solid line) extends across a protruding segment of the pattern element 81.

FIGS. 8(b) and 8(c) show schematic layouts of respective portions of the segmented reticle used to define the pattern element 81 for projection onto the substrate. Two subfields 87 are shown in each figure, wherein each subfield comprises a respective pattern-defining region 83 and skirt 85. In each subfield 87 the skirt 85 surrounds the respective pattern-defining region 83 and abuts the struts 84. Each pattern-defining region 83 contains a respective portion of the pattern designated to be situated within the corresponding subfield-division boundaries. The skirt 85 normally is not patterned. However, the skirt 85 helps make exposure of the respective subfield possible whenever, e.g., the charged particle beam experiences positional drift and exposes a portion of the subfield outside the pattern-defining region 83. The skirt 85 also helps prevent thermal deformation of the reticle membrane of the respective subfield caused by exposure to the charged particle beam.

The portion of each skirt 85 at the periphery of each pattern-defining region 83 (denoted by dot-dash line) is termed a respective “superposable” region 86. The superposable region 86 may be used to project a portion of a pattern element onto the substrate in the same manner as the pattern-defining region 83. As the name “superposable region” indicates, any portion of a pattern element extending into a superposable region 86 and projected onto the substrate is superposed onto the adjacent transferred subfield.

In FIG. 8(b) the pattern element 81 is divided along the division boundary such that a protruding portion 81a of the pattern element 81 is situated in the adjacent subfield. By comparison, FIG. 8(c) shows the same two subfields 82, but with the portion 81a extending into the superposable region 86 of the same subfield 82 that defines the rest of the pattern element 81. By allowing the portion 81 a to extend into the superposable region 86 as shown in FIG. 8(c), the contiguity of the pattern element 81 is preserved and adverse consequences of a stitching error are correspondingly reduced.

Positioning the pattern element 81 as shown in FIG. 8(c) should be performed while taking into account certain considerations. For example, performing correction processing S5 (FIG. 1) likely will involve local resizing of the pattern element 81, resulting in, for example, enlarged and/or serifed corners of the element 81 as defined on the reticle. In FIG. 8(c), the outer edge of the superposable region 86 is denoted by the line 88. So long as the right end of the element 81 is situated at least a distance “x” from the line 88, local resizing of the right-hand end of the element 81 can be performed while still allowing the element 81 to be situated within the left-hand subfield 87. The value of “x” can be constant for all subfields or can vary from subfield to subfield. However, x≠0 because otherwise no local resizing of the element 81 could be accommodated if the element is to be placed entirely within a single subfield.

The size of the superposable region 86 is dictated by the range in which uniform beam illumination can be maintained beyond the pattern-defining region 83. Although this range is adjustable to a limited extent, the superposable region 86 cannot extend beyond the perimeter of the skirt 85. By adjusting this range appropriately, the superposable region 86 can be effectively utilized for accurately transferring critical elements of the pattern that otherwise would be divided by the division boundaries. Consequently, unnecessary pattern division may be prevented and stitching errors reduced. To further aid in optimizing the design of the pattern as defined on the reticle, fine adjustments can be made automatically to the respective sizes of the subfields, skirts, and struts.

As noted above, subfield-division processing at step S303 comprises dividing the transfer pattern into multiple subfields according to the system data input at step S301. In one embodiment, using the superposable regions to minimize unnecessary pattern-element division, as discussed above, is employed at step S303. In another embodiment, only strict division of the pattern into subfields occurs at step S303, and further processing to avoid unnecessary pattern-element division does not occur until avoidance-processing S6 is performed.

After completing subfield-division processing at step S303, there is a shift to step S8 to determine whether further processing is necessary. In one embodiment, the operator is prompted during subfield-division processing whether stripe-division processing S4 and display processing S7 should be performed. If the operator responds in the affirmative, then the process routines S4 and S7 are performed consecutively after completion of subfield-division processing S3.

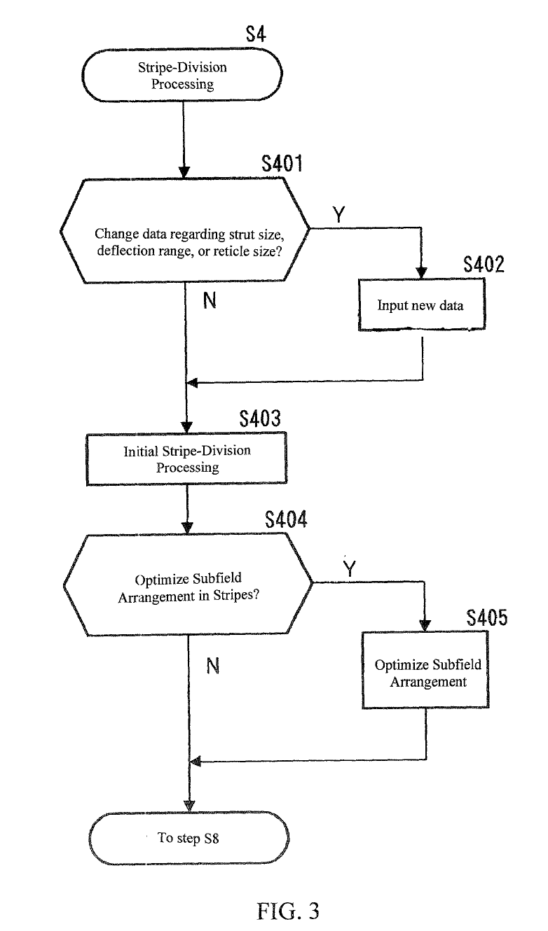

FIG. 3 is a flowchart showing an overview of stripe-division processing S4. During stripe-division processing S4, the results of pattern division achieved during subfield-division processing S3 are reviewed, and a determination is made of the best manner in which to arrange the subfields into respective stripes of the segmented reticle. This determination is based upon variables such as the deflection range (maximal distance of lateral deflection) achievable with the charged particle beam.

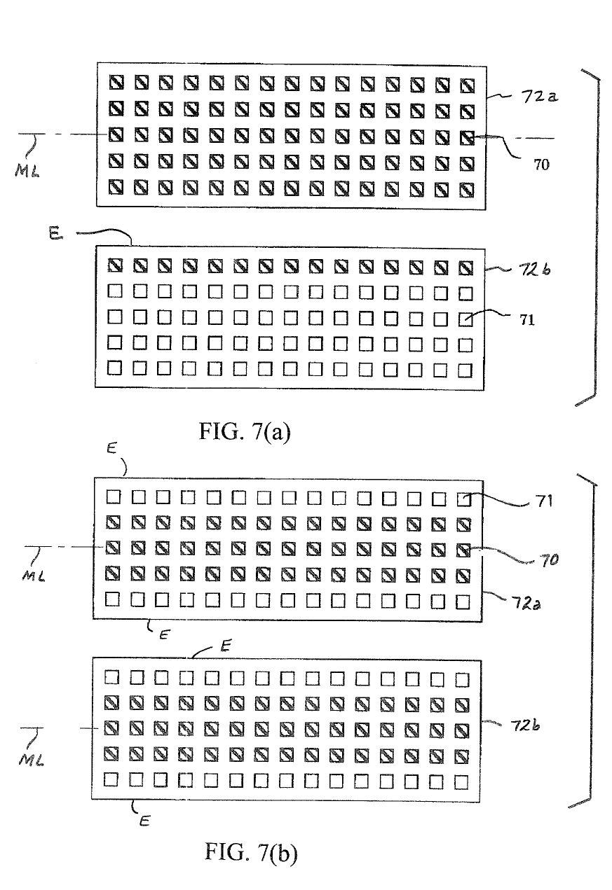

An exemplary stripe-division process S4 for achieving optimal subfield locations within stripes is depicted in the schematic plan views in FIGS. 7(a)-7(b). In FIG. 7(a), two stripes 72a, 72b are shown each containing fifteen rows of five subfields (denoted by small squares) each. The hatched subfields 70 are “patterned” subfields (each containing a respective portion of the reticle pattern). The non-hatched subfields 71 are “empty” subfields (containing no portion of the pattern).

It is normal for the number of subfields available on a reticle to exceed the number of subfields actually necessary for defining an entire pattern. A conventional manner of dividing the pattern-defining subfields is shown in FIG. 7(a), in which all the subfields of one stripe 72a are patterned, leaving a disproportionate number of the available subfields in another stripe empty.

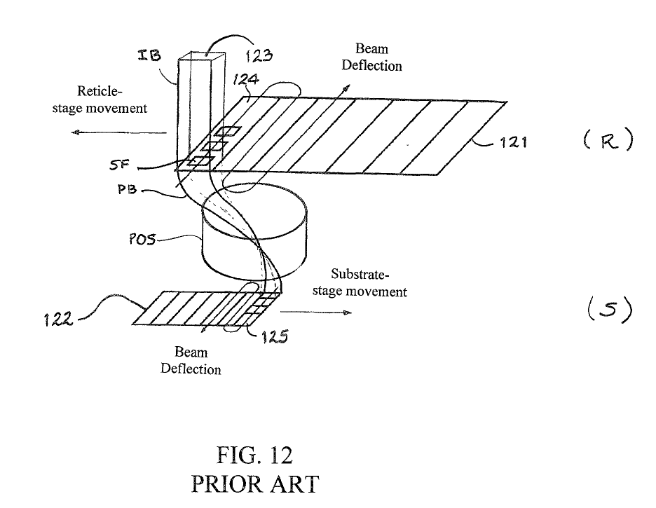

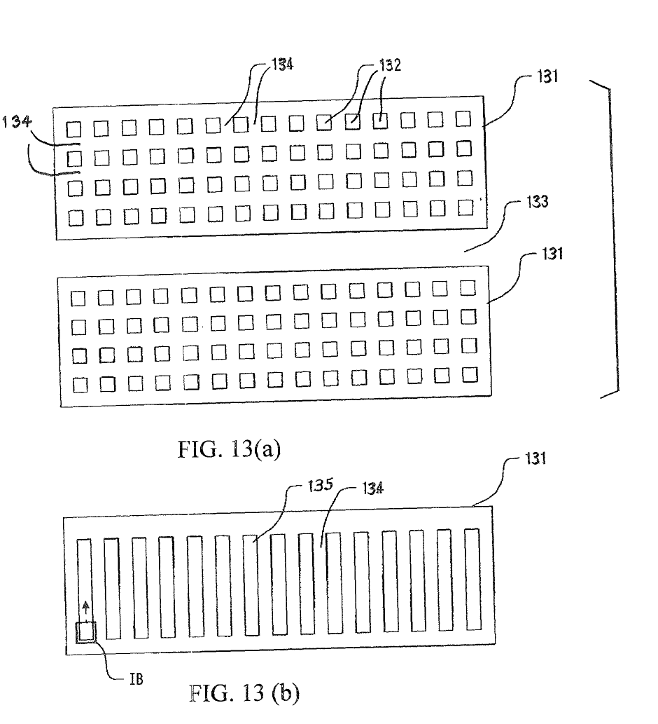

The arrangement of subfields shown in FIG. 7(a) can have adverse effects on the quality of pattern transfer. Referring again to FIG. 12, and as discussed earlier above, the illumination beam IB is deflected laterally as required to expose the subfields in each row in a sequential and continuous manner. This deflection of the beam causes “deflection aberrations” that can have an adverse effect on the quality of the subfield images as transferred to the substrate. The magnitude of deflection aberrations is proportional to the degree of beam deflection; hence, the greatest deflection aberrations tend to occur with subfields located at the ends of rows. As a result, it is desirable that patterned subfields be positioned centrally (i.e., near a longitudinal mid-line ML of the stripe) within the rows, if possible.

In the stripe 72b of FIG. 7(a), patterned subfields are situated at the ends of rows (i.e., along an opposing longitudinal edge E of the stripe). By changing the subfield arrangement to the arrangement shown in FIG. 7(b), the patterned subfields 70 within the rows of both stripes 72a, 72b are situated near the longitudinal mid-line ML of each stripe, thereby placing empty subfields 71 at the ends of the rows (near the longitudinal edges E). Consequently, deflection aberrations are reduced by the scheme shown in FIG. 7(b).

The steps in stripe-division processing are shown in the flowchart of FIG. 3. In FIG. 3, it is assumed that subfield-division processing S3 occurred previously. In step S401, a determination is made as to whether any of the data concerning strut size, beam-deflection range, or reticle size should be changed. If so, then the new data is input manually or by other suitable manner in step S402. After new data is input, or after step S401 has resulted in a determination that no new data is necessary, an initial stripe division occurs at step S403.

During initial stripe division S403, the multiple patterned subfields resulting from subfield-division processing S3 are arranged into the one or more stripes of the segmented reticle. Initially, this arrangement is performed in a straightforward manner. For example, if each stripe contains fifteen rows of five subfields each, then the pattern-defining subfields are arranged into blocks of fifteen rows of five subfields each and assigned to the first available stripes.

After completing initial stripe division S403, a determination is made at step S404 of whether the initial arrangement of the subfields in the stripes needs optimization. If optimization is required, then the subfield arrangement is optimized at step S405. Subfield-arrangement optimization proceeds in the manner described above in connection with FIGS. 7(a)-7(b) and involves arranging the subfields so that they are centrally located, if possible, within the stripes of the reticle (i.e., preferentially located near the respective longitudinal mid-lines of the stripes). After optimizing the subfield arrangement, or if optimization of subfield arrangement is not required, then a determination is made at step S8 as to whether any further processing is necessary.

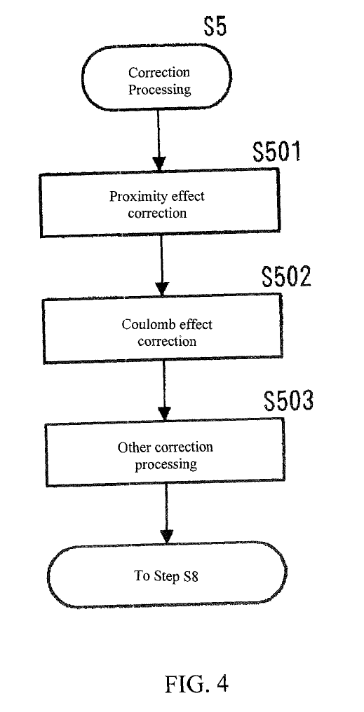

FIG. 4 is a flowchart providing an overview of correction processing S5. In FIG. 4, it is assumed that subfield-division processing S3 occurred before commencing correction processing S5. Because there are various types of corrections that can be applied, not all of the correction steps shown in FIG. 4 are necessarily performed. Instead, the operator or the screen editor may select which correction steps to perform, based on prevailing circumstances.

At step S501, proximity-effect corrections are made using one of several available techniques. The “proximity effect” is caused by the interaction of charged particles in the charged particle beam with atoms of the resist on the substrate. This interaction causes some of the particles of the beam to back-scatter and/or generate secondary electrons. The back-scattered particles and secondary electrons expose the resist on the substrate at unexpected and unintended locations. For correcting proximity effects, among the available techniques are: (1) the GHOST technique described in U.S. Pat. No. 4,463,265 (which utilizes a second exposure of a complementary subfield); (2) the representative-diagram GHOST technique described in Japan Kôkai Patent Document No. Hei 6-208944 (which uses “representative diagrams” of pattern elements in subfields); and (3) “local resizing.” In local resizing the consequences of proximity effects on pattern transfer are calculated in advance, and pattern elements as defined on the reticle are resized and reshaped as required to compensate for these effects. For example, the profile of a pattern element on the reticle is modified to include serifs and the like, wherein the modified pattern element, when transferred to the substrate, more exactly matches the desired shape of the element compared to an unmodified element.

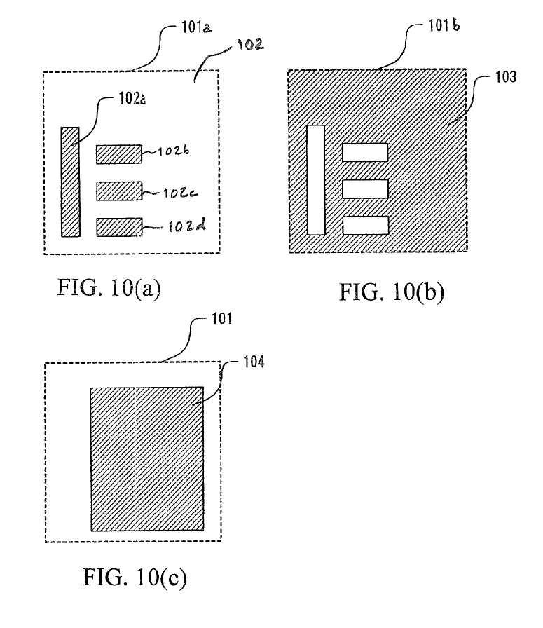

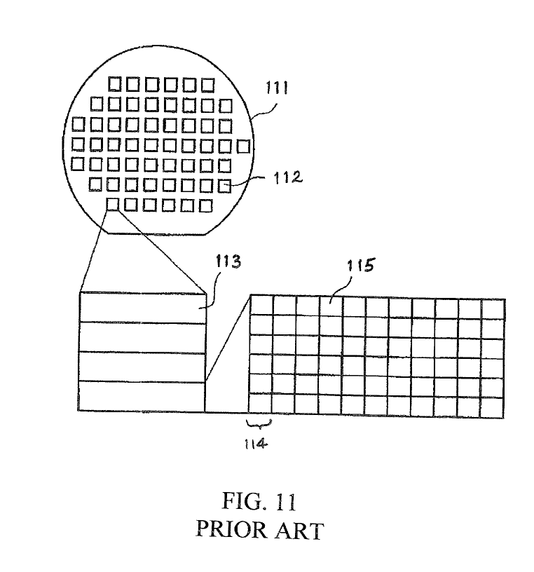

FIGS. 10(a)-10(c) schematically show proximity-effect correction using several GHOST methods. In FIG. 10(a), a subfield 101a contains a respective pattern portion 102 including four pattern elements 102a-102d. The corresponding complementary subfield 101b is shown in FIG. 10(b), in which the subfield defines a pattern portion 103 that is the inverse of the pattern portion 102. In a first, or “primary,” exposure, the subfield in FIG. 10(a) is projected onto the substrate using a focused beam. Then, in a secondary exposure, the subfield in FIG. 10(b) is projected onto the same area of the substrate using a defocused beam. When performed correctly, the background dose caused by the primary exposure is offset by the background dose of the secondary exposure such that all regions of the exposed area have a constant background dose.

Alternatively, a secondary exposure using a “representative diagram” of the respective pattern elements such as the feature 104 shown in FIG. 10(c) may be used to achieve nearly the same effect as the technique shown in FIGS. 10(a)-10(b).

At step S502, coulomb-effect correction is performed using one of several known techniques. The “coulomb effect” is caused by the repulsive force between like-charged particles in the charged particle beam. This repulsive force causes the beam to diffuse, thereby blurring any projected image. Exemplary techniques that may be used for correcting the coulomb effect are disclosed in Japan Kôkai Patent Document No. 2001-93831 (U.S. patent application Ser. No. 09/620,760, incorporated herein by reference). These techniques involve calculating image blur, caused by the coulomb effect, taking into account variables such as the beam-current density and the current-density distribution. According to the results of the calculations, the elements are reshaped on the reticle before exposure to compensate for the coulomb effect.

At step S503, any other required correction processing is performed. Note that these correction processes may be performed in any order and need not all be performed. After correction processing is completed, a determination is made at step S8 as to whether any further processing is necessary.

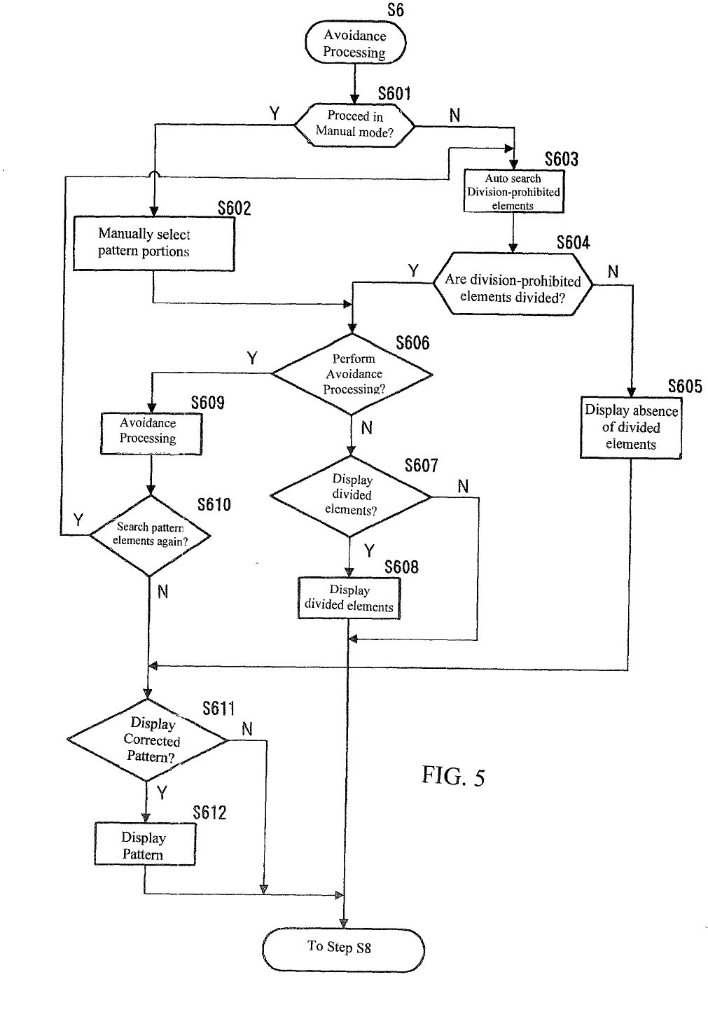

FIG. 5 is a flowchart showing an overview of avoidance processing S6. In FIG. 5 it is assumed that subfield-division processing S3 has been completed before commencing avoidance processing S6. Performing avoidance processing S6 prevents certain critical portions of the pattern from being divided by subfield-division boundaries.

In general, avoidance processing may be performed in either a “manual” or “automatic” mode. In the manual mode, the operator manually selects those portions of the divided pattern on which to perform avoidance processing. In the automatic mode, certain “division-prohibited pattern elements” are preset (by the operator or otherwise), and the divided pattern is searched automatically for the presence of the division-prohibited elements. If any division-prohibited elements are found, then an evaluation is made as to whether the subject pattern elements are divided and, if necessary, avoidance processing is performed on the subject elements to correct the division problems.

At step S601, a determination is made as to whether avoidance processing should proceed in manual mode. If manual mode is selected, then, at step S602, the operator manually may select portions of the divided pattern to be processed. Data relating to these selected portions are extracted, and a determination is made at step S606 whether avoidance processing should be performed on the extracted data.

If automatic mode is selected, then, at step S603, an automatic search of the pattern is performed. This automatic search function locates and extracts any division-prohibited pattern elements. Although any method for recognizing division-prohibited pattern elements may be employed, one possible method exploits the capacity of a screen editor to use certain geometric profiles (or certain patterns of multiple profiles) to represent certain circuit elements. By designating as “division-prohibited” those pattern-element profiles corresponding to active or critical elements that should not be divided (e.g., transistors or contact holes), the automatic search function locates the portions and extracts the necessary data.

The automatic search function also may be utilized to locate linear pattern elements having widths less than a predetermined minimum. This function also may be used to extract information using the screen editor's design-rule-checking (DRC) function.

After automatic searching is executed at step S603, the extracted data are evaluated at step S604 to determine whether any of the extracted division-prohibited pattern elements are, in fact, divided by a division boundary. If no such divided pattern elements are found, then this result is displayed to the user at step S605, accompanied by a shift to step S611, where a determination is made as to whether the corrected pattern should be displayed. If divided pattern elements are found, then a shift is made to step S606, where a determination is made as to whether avoidance processing should be performed. The screen editor may be set so that avoidance processing is always performed, in which case step S606 simply checks whether the editor is in an avoidance-processing mode or not.

If the screen editor is not in an avoidance-processing mode, or if step S606 resulted in a determination that avoidance processing should not be performed, then a shift is made to step S607. At step S607, a determination is made as to whether the divided pattern elements should be displayed. If the result is affirmative, then the pattern elements are displayed at step S607. During display, the divided pattern portions may be shown, for example, in a different color than the other pattern elements so that they may be discerned easily by the operator. After the pattern portions are displayed or step S607 yields a determination not to display the divided pattern elements, avoidance processing ends at step S8.

If the screen editor is in avoidance-processing mode, or if step S606 resulted in a determination that avoidance processing should be performed, then a shift from step S606 to step S609 occurs. At step S609, avoidance processing is performed by utilizing the superposable region in the manner described above or by using an automatic wiring function.

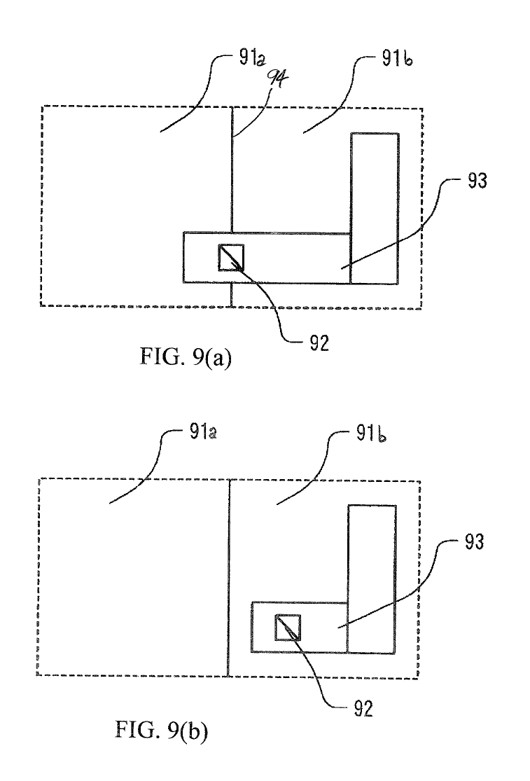

FIGS. 9(a)-9(b) are plan views schematically illustrating use of the automatic wiring function to avoid division of a selected pattern element. In FIG. 9(a), two pattern-defining subfields 91a, 91b are shown that contain an L-shaped wiring element 93 extending across the subfield (division) boundary 94. The L-shaped wiring element 93 includes a region 92 that presents a transfer problem because it is situated on (and thus is divided by) the division boundary 94. As illustrated in FIG. 9(b), however, the automatic wiring function can locate such regions and automatically adjust the profile of the wiring element 93 so as to avoid dividing the region 92.

At times, avoidance processing will create division problems inadvertently in other regions of the divided pattern. Therefore, after avoidance processing is completed at step S609, a determination is made at step S610 as to whether the divided pattern should be searched again for any new division problems. The screen editor may be set to a mode in which a new search is always performed upon completion of avoidance processing. If a new search is to be performed, then the process returns to step S603. Otherwise, the process shifts to step S611.

At step S611, a determination is made as to whether the corrected elements should be displayed. If the result is affirmative, then the process shifts to step S6 12, and the display is made. After the corrected elements are displayed at step S612, or if the determination at step S611 is that the corrected elements need not be displayed, then avoidance processing ends and the process shifts to step S8.

It should be noted that, whenever a pattern is transferred using gradient-sloped illumination such as that described in U.S. Pat. No. 6,201,598, the number of subfields on the segmented reticle tends to increase. Gradient-sloped illumination involves dividing the pattern into multiple overlapping regions and using the overlapping regions to define the subfields. During transfer exposure, each respective subfield is transferred using a half-normal exposure dose. However, by also exposing the respective overlapping subfields at a half-exposure dose, a complete exposure at net normal dose ultimately is obtained for the entire pattern. By exposing each pattern portion twice, gradient-sloped illumination has the effect of alleviating slight positional displacements. There are circumstances, however, when certain pattern portions defining unique structural elements should not be transferred using gradient-sloped illumination. If gradient-sloped illumination is used, avoidance processing also may be performed on the pattern portion contained in the overlapping region. Additionally, the overlapping regions can be displayed so that the operator may identify and evaluate the regions and change their dimensions if desired.

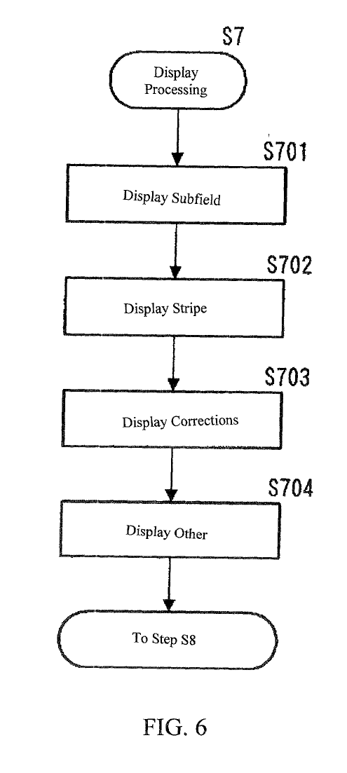

FIG. 6 is a flow chart showing an overview of display processing S7. Display processing S7 comprises several independent display processes S701-S704 that need not be performed together. Instead, step S8 designates which of these display processes should be performed, based on the particular processing at steps S3-S6 that was just completed. Because step S8 often determines that display processing should occur upon completion of any processing step, display processing typically is utilized several times during use of the screen editor.

Step S701 comprises subfield display. In one mode of subfield display S701, the skirts, struts, overlapping regions, superposable regions, and other portions of the divided pattern are displayed. In another mode, the pattern is displayed with the division boundaries superimposed (e.g., division boundaries may be shown by dashed lines).

Step S702 comprises stripe display, in which the stripes and the subfields within the stripes are displayed in a manner allowing the patterned subfields to be distinguished from the empty subfields. This manner of display allows the operator to determine whether the particular assignment of subfields to stripes is appropriate.

Step S703 comprises correction display, in which the corrected portions of the divided pattern (or the subfields in which the corrected portions are located) are displayed either individually or as they appear throughout the pattern. For instance, an operator may find it helpful to display each corrected pattern element individually immediately after a correction occurs so that the operator can evaluate and confirm the result manually. Additionally, if the GHOST technique is utilized to perform proximity-effect correction, the respective inverted profile of or the representative diagram for a subject subfield can be displayed. Moreover, corrected pattern elements and other pattern portions may be displayed in a separate window of the screen so that the pattern can be shown simultaneously with the corrected portion. Additionally, the operator may change the “magnification” of any of the displays.

Other display processing may be performed as required at step S704.

The methods described above preferably are embodied in a screen editor capable of automatically dividing a pattern into the respective subfields and stripes used to form a segmented reticle pattern. Such automatic division allows the pattern to be transmitted directly to a mask writer without further modification. Also, an operator using the screen editor can design a pattern while taking relevant division boundaries into consideration. These methods result in reduced time in which pattern designs are made, with an overall reduction in costs associated with chip production.

The screen editor additionally is capable of searching for and extracting critical elements of the pattern that are divided by subfield-division boundaries. Based on such data, the screen editor can correct these elements automatically under the operator's supervision. Consequently, the possibility of a defective product is reduced.

The screen editor is further capable of displaying the divided pattern so that the operator can evaluate and adjust both the pattern design and the manner of dividing the pattern, as necessary. In particular, the screen editor allows the operator to adjust the sizes of the subfields, skirts, superposable regions, and struts used in pattern division. Hence, if the initial reticle pattern is inappropriate, then the operator can adjust these parameters to derive a more appropriate pattern division.

The screen editor also is capable of displaying the major and minor struts of the divided reticle. Such a display allows an operator to evaluate the overall quality of the reticle pattern in light of these features, and to perform any necessary design changes.

The screen editor also is capable of correcting the divided pattern for errors caused by proximity effects and coulomb effects. These corrections are performed only after the pattern has been divided, which helps to ensure overall accuracy of the transferred pattern. The screen editor also can display calculations associated with these corrections so that the operator may determine whether the scale of the correction is appropriate and whether the correction will result in any adverse effects.

Whereas the invention has been described in connection with representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. A method for converting a pattern design into a divided-reticle pattern on a segmented reticle for use in a charged-particle-beam (CPB) microlithography system, the method comprising:
on a data set including current pattern-design data and current reticle data, performing multiple process routines so as to produce reticle-fabrication data, the multiple process routines including display processing and at least one of subfield-division processing and stripe-division processing, correction processing; and
based on results obtained during the at least one process routine, converting the pattern design into the divided-reticle pattern.

2. The method of claim 1, wherein, during the converting step, the pattern design is divided among multiple subfields of the divided reticle.

3. The method of claim 1, wherein the current reticle data comprises dimensional and configurational data concerning one or more of: the overall reticle, major and minor struts of the reticle, individual stripes of the reticle, individual rows of a stripe, individual subfields of a row, and pattern-defining regions, skirts, and superposable regions of the subfields.

4. The method of claim 1, wherein the data set further comprises current microlithography system data, including data concerning one or more of: aberrations, beam-acceleration voltage, beam current, range of lateral beam deflection, etching conditions, and reticle-processing conditions.

5. The method of claim 1, wherein the step of performing multiple process routines comprises performing both subfield-division processing and stripe-division processing.

6. The method of claim 1, wherein subfield-division processing comprises converting, from the data set, the pattern design into the divided-reticle pattern.

7. The method of claim 6, wherein the data set comprises current microlithography-system data provided by:
determining whether to update the microlithography-system data; and
if updating is indicated, then updating the microlithography-system data.

8. The method of claim 6, wherein the step of converting the pattern design into the divided-reticle pattern comprises the steps of:
searching the divided-reticle pattern for pattern portions defining respective critical pattern elements extending across respective subfield-division boundaries; and
for such pattern portions that are found, configuring the respective critical elements so as to extend into respective superposable regions of respective subfields rather than across respective subfield-division boundaries.

9. The method of claim 1, wherein stripe-division processing comprises arranging, from the data set, subfields of the pattern into stripes.

10. The method of claim 9, wherein the current reticle data in the data set comprises dimensional data concerning one or more of: the overall reticle, major and minor struts of the reticle, and individual stripes of the reticle.

11. The method of claim 10, wherein the current reticle data is provided by:
determining whether to update the reticle data; and
if updating is indicated, then updating the reticle data.

12. The method of claim 9, wherein the step of arranging the subfields into stripes comprises:
performing a first arrangement of the subfields into at least one stripe having opposing longitudinal edges and a longitudinal mid-line; and
if, in the first arrangement, the stripe contains both patterned subfields and empty subfields, then arranging the patterned subfields preferentially along the mid-line and the empty subfields preferentially along the longitudinal edges, thereby providing an optimal arrangement of subfields in the stripe.

13. The method of claim 9, wherein the step of arranging the subfields into stripes comprises:
performing a first arrangement of the subfields into multiple stripes each having respective opposing longitudinal edges and a respective longitudinal mid-line; and
if, in the first arrangement, at least one stripe contains both patterned subfields and empty subfields, then arranging the patterned subfields preferentially along the respective mid-lines of the stripes and the empty subfields preferentially along the respective longitudinal edges of the stripes, thereby providing an optimal arrangement of subfields in the stripes.

14. The method of claim 1, further comprising the step of performing at least one of correction processing and avoidance processing.

15. The method of claim 14, wherein correction processing comprises:
calculating an impact of the proximity effect on expected pattern-transfer accuracy of the divided-reticle pattern; and
correcting the divided-reticle pattern to compensate, at least in part, for the proximity effect.

16. The method of claim 15, wherein the step of correcting the divided-reticle pattern is accomplished using a GHOST technique.

17. The method of claim 14, wherein correction processing comprises:
calculating an impact of the coulomb effect on expected pattern-transfer accuracy of the divided-reticle pattern; and
correcting the divided-reticle pattern to compensate, at least in part, for the coulomb effect.

18. The method of claim 17, wherein the step of correcting the divided-reticle pattern comprises:
calculating image blur expected to be caused by the coulomb effect; and
reshaping and resizing selected elements of the pattern as required to reduce the coulomb effect.

19. The method of claim 14, wherein avoidance processing comprises:
searching the divided-reticle pattern for pattern portions defining respective critical pattern elements, and determining whether the critical pattern elements extend across respective division boundaries;
for such critical pattern portions that are found, determining whether the respective critical elements can be corrected so as not to extend across respective division boundaries; and
for such critical pattern portions that can be corrected, correcting the respective critical elements.

20. The method of claim 19, wherein the searching step is performed manually.

21. The method of claim 19, wherein the searching step is performed in an automated manner.

22. The method of claim 19, wherein the searching step includes displaying the pattern portions defining respective critical pattern elements extending across respective division boundaries.

23. The method of claim 19, further comprising the step of displaying the corrected critical elements.

24. The method of claim 1, wherein display processing comprises performing at least one of subfield display and stripe display.

25. The method of claim 24, wherein subfield display comprises displaying at least a portion of the divided-reticle pattern with at least one line representing a subfield-division boundary superimposed on the displayed pattern.

26. The method of claim 25, wherein subfield display further comprises displaying any minor struts and major struts associated with the displayed pattern.

27. The method of claim 24, wherein stripe display comprises displaying at least one stripe of the divided-reticle pattern showing an arrangement of patterned versus empty subfields in the stripe.

28. The method of claim 1, wherein:
the step of performing multiple process routines further comprises performing correction processing; and
display processing comprises performing correction-processing display.

29. The method of claim 28, wherein correction-processing display comprises displaying at least one corrected portion of the divided-reticle pattern.

30. The method of claim 29, wherein, in the displayed corrected portion, corrected pattern elements are distinguishable from uncorrected pattern elements.

31. The method of claim 28, wherein correction-processing display comprises displaying at least one pattern portion for application of a GHOST technique.

32. The method of claim 28, wherein correction-processing display comprises displaying, together with a corrected portion of the divided-reticle pattern, at least one set of calculations accompanying corrections made to the corrected portion.

33. The method of claim 1, further comprising the step, after the converting step, of routing the divided-reticle pattern to a mask writer.

34. A computer program, encoding the method of claim 1.

35. A computer-readable medium, comprising the computer program of claim 34.

36. A computer, programmed with the computer program of claim 34.

37. A screen editor for use in designing a divided-reticle pattern to be transferred lithographically from a segmented reticle to a substrate using a charged-particle-beam (CPB) microlithography system, comprising:
means for receiving a data set relating to a design of a pattern to be transferred to the substrate and current reticle configuration;
means for converting, according to the received data, the pattern design into a corresponding divided-reticle pattern in which the pattern is divided into at least one of subfields and stripes.

38. The screen editor of claim 37, further comprising means for displaying at least selected portions of the pattern during at least one of before, during, and after conversion of the pattern design into the corresponding divided-reticle pattern.

39. The screen editor of claim 37, wherein said means for converting comprises:
means for identifying, during conversion, pattern elements that could be problematical when transferred from the segmented reticle; and
means for correcting said pattern elements to avoid problems during transfer.

40. The screen editor of claim 37, wherein said means for receiving the data set comprises manual data-input means.

41. The screen editor of claim 40, wherein said manual data-input means is configured to receive current-reticle dimensional and configurational data regarding one or more of: subfields, skirts, superposable regions, and struts.

42. The screen editor of claim 37, wherein said means for converting comprises means for dividing the pattern into multiple subfields according to the received data.

43. The screen editor of claim 42, wherein said means for converting further comprises:
means for performing a first arrangement of the multiple subfields into at least one stripe having opposing longitudinal edges, a longitudinal mid-line, and at least one row of respective subfields; and
means for performing, if in the first arrangement the stripe contains both patterned subfields and empty subfields, a second arrangement in which patterned subfields of the stripe are arranged preferentially along the mid-line and the empty subfields are arranged preferentially along the respective longitudinal edges of the stripe.

44. The screen editor of claim 42, wherein said means for converting further comprises:
means for calculating an impact of the proximity effect on expected pattern-transfer accuracy of the divided-reticle pattern; and
means for correcting the divided-reticle pattern to compensate, at least in part, for the proximity effect.

45. The screen editor of claim 42, wherein said means for converting further comprises:
means for calculating an impact of the coulomb effect on expected pattern-transfer accuracy of the divided-reticle pattern; and
means for correcting the divided-reticle pattern to compensate, at least in part, for the coulomb effect.

46. The screen editor of claim 42, wherein said means for converting further comprises:
means for searching the divided-reticle pattern for pattern portions defining respective critical pattern elements and for determining whether the critical pattern elements extend across respective division boundaries; and
means for correcting, for such pattern portions that are found, the respective critical elements so as not to extend across the respective division boundaries.

47. The screen editor of claim 46, wherein said means for correcting reconfigures a respective critical element so as to extend no further than into a superposable region of a respective subfield containing the critical element.

48. The screen editor of claim 46, wherein said means for correcting reconfigures a respective critical element such that the respective division boundary does not divide the element.

49. A computer-readable medium, comprising a program for a screen editor as recited in claim 37.

50. A computer, programmed with the screen editor recited in claim 37.

51. A method for converting a pattern design into a divided-reticle pattern, comprising:
dividing the pattern design into multiple subfields according to predetermined dimensions and configurations of subfields, respective pattern-defining regions in the subfields, and skirts in the subfields, the subfields defining respective portions of the pattern; and
displaying the divided-reticle pattern.

52. The method of claim 51, further comprising the steps of:
arranging the multiple subfields into at least one stripe according to predetermined dimensions and configurations of stripes, major struts, and minor struts; and
displaying the arranged subfields.

53. The method of claim 52, wherein the arranged subfields include patterned subfields and empty subfields, the method further comprising the steps of:
in the at least one stripe, determining whether the patterned subfields and empty subfields are optimally located within respective rows of the stripe;
if the patterned subfields and empty subfields are not optimally located in the at least one stripe, then rearranging the subfields to establish an optimal arrangement of subfields within the at least one stripe; and
displaying the rearranged subfields.

54. The method of claim 51, further comprising the steps of:
in the subfields, calculating impacts of proximity effects;
as required, correcting the divided-reticle pattern to compensate for the proximity effects; and
displaying the corrected divided-reticle pattern.

55. The method of claim 51, further comprising the steps of:
in the subfields, calculating impacts of coulomb effects;
as required, correcting the divided-reticle pattern to compensate for the coulomb effects; and
displaying the corrected divided-reticle pattern.

56. The method of claim 51, further comprising the steps of:
searching the divided-reticle pattern for pattern portions defining respective critical pattern elements extending across respective division boundaries of the pattern;
for critical pattern elements found extending across respective division boundaries of the pattern, correcting the respective pattern portions so as not to extend across the respective division boundaries; and
displaying the corrected divided reticle pattern.

57. The method of claim 56, wherein the step of correcting the respective pattern portions comprises, for each such pattern portion, configuring the respective critical pattern element to extend into a respective superposable region of the respective subfield, according to predetermined dimensions and configurations of the superposable regions.

58. The method of claim 56, wherein the step of correcting the respective pattern portions comprises, for each such pattern portion, configuring the respective pattern portion so that the respective division boundary does not divide the respective pattern portion.

59. A computer program, encoding the method of claim 51.

60. A computer-readable medium, comprising the computer program of claim 59.

61. A computer, programmed with the computer program of claim 59.
